(19) United States
(12) Patent Application Publication
(10) Pub. No.: US 2025/0232222 A1
(43) Pub. Date: Jul. 17, 2025

(54) LEARNING MODEL PROCESSING DEVICE, REMOTE LEARNING SYSTEM, AND NON-TRANSITORY COMPUTER READABLE MEDIUM

(71) Applicant: FUJIFILM Corporation, Tokyo (JP)

(72) Inventors: Yutaka OISHI, Tokyo (JP); Yasuyuki FURUKAWA, Tokyo (JP)

(73) Assignee: FUJIFILM Corporation, Tokyo (JP)

(21) Appl. No.: 19/023,221

(22) Filed: Jan. 15, 2025

(30) Foreign Application Priority Data
Jan. 16, 2024 (JP) 2024-004587

(51) Int. Cl. G06N 20/00; G06Q 30/0283; G06Q 30/04

(52) U.S. Cl. CPC G06N 20/00; G06Q 30/0283; G06Q 30/04

(57) ABSTRACT

The present invention includes a processor, in which the processor receives transmission of an encrypted learning model from a learning model generation device, acquires a dataset for a learning model, trains the learning model by using the dataset for a learning model through confidential computation, to derive an encrypted trained model, and transmits the trained model to the learning model generation device.

### CROSS-REFERENCE TO RELATED APPLICATIONS

This application claims priority under 35 U.S.C § 119(a) to Japanese Patent Application No. 2024-004587 filed on 16 Jan. 2024. The above application is hereby expressly incorporated by reference, in its entirety, into the present application.

### BACKGROUND OF THE INVENTION

### 1. Field of the Invention

The present invention relates to a learning model processing device, a remote learning system, and a non-transitory computer readable medium.

### 2. Description of the Related Art

In a case in which machine learning is performed on a learning model, which is generated by a data user such as a pharmaceutical company or a medical device manufacturer, by using pieces of health information of a plurality of individuals, it is necessary to transfer and take out the health information from a data management base such as a health checkup facility or a medical institution that manages the health information to a data use base managed by the data user, or it is necessary to move the learning model for the machine learning to the data management base. The health information includes personal information, and a large amount of health information is required to be input for the machine learning. On the other hand, in a case in which the learning model is moved, the learning model, which is confidential information, is disclosed to the data management base side.

WO2023/119421A (corresponding to US2024/0273220A1) describes a distributed machine learning system that provides an encrypted trained model between a client device and a server device by using a secure communication path established by mutually verifying correctness of activation. The server device provides an encrypted client model from each client device, and the server device provides an encrypted global model to each client device. In addition, it is described that the server device aggregates a plurality of client models provided from the client devices in a state of being homomorphically encrypted, to obtain a homomorphic encryption global model.

### SUMMARY OF THE INVENTION

WO2023/119421A describes that the trained learning model is transmitted between different devices and that the plurality of trained models are aggregated into one trained model in a state of being homomorphically encrypted, but does not describe that the machine learning is performed by inputting data for a learning model to encrypted model information at a transmission destination, and thus there is a risk that a learning model in its encrypted state cannot be used for the machine learning.

An object of the present invention is to provide a learning model processing device, a remote learning system, and a non-transitory computer readable medium storing a computer-executable program for performing, in a non-disclosed state, machine learning on a learning model transmitted from a different device without taking out data for a learning model.

An aspect of the present invention relates to a learning model processing device comprising: a processor, in which the processor receives transmission of an encrypted learning model from a learning model generation device, acquires a dataset for a learning model, trains the learning model by using the dataset for a learning model through confidential computation, to derive an encrypted trained model, and transmits the trained model to the learning model generation device.

It is preferable that the processor divides the dataset for a learning model, which is acquired in advance, into a training dataset and an evaluation dataset, inputs the evaluation dataset to the trained model to acquire an evaluation result, and transmits quality data based on the evaluation result to the learning model generation device.

It is preferable that the processor performs anonymization processing on the evaluation result to generate the quality data.

It is preferable that the processor decides a price of the trained model to be paid by a user from the evaluation result, and transmits a billing amount based on the price to the learning model generation device.

It is preferable that the processor decides the price according to a type of data included in the dataset for a learning model.

It is preferable that the processor acquires a training-time evaluation result indicating accuracy during training, in the derivation of the trained model, calculates an overfitting degree from a deviation amount between the training-time evaluation result and the evaluation result, and reduces the billing amount according to the overfitting degree.

It is preferable that the processor stores a provider of data constituting the dataset for a learning model, receives response variable information for designating a condition of the data constituting the dataset for a learning model, together with the learning model, from the learning model generation device, and decides a reward amount to be paid, for each provider, based on the price, the response variable information, and a total number of records of the dataset for a learning model.

It is preferable that the processor groups the providers according to a type of data in the response variable information, and sets the reward amount to be paid to the provider of data that matches the type to be higher than the reward amount to be paid to the provider of data that does not match the type.

It is preferable that the processor presents the reward amount and the response variable information to the provider.

It is preferable that the dataset for a learning model is a health-related dataset, and the trained model is a trained model that has been trained by using health-related data.

Another aspect of the present invention relates to a remote learning system, in which datasets for a learning model used to train a learning model are distributed and held in a plurality of learning model processing devices as different datasets for a distributed learning model, the learning model processing devices perform distributed learning by using a confidential computation unit on the learning model, which is generated and encrypted by a learning model generation device, by using the datasets for a distributed learning model held in the respective learning model processing devices, and the learning model generation device receives input of a trained model derived by the distributed learning.

It is preferable that the remote learning system includes, as the plurality of learning model processing devices that perform the distributed learning, a first learning model processing device that holds a first dataset for a distributed learning model that is the dataset for a distributed learning model, and a second learning model processing device that holds a second dataset for a distributed learning model that is the dataset for a distributed learning model, the first learning model processing device inputs the first dataset for a distributed learning model to the learning model transmitted from the learning model generation device and derives an in-middle-of-learning model that has stopped learning in a state in middle of learning, and the second learning model processing device acquires the in-middle-of-learning model transmitted from the first learning model processing device, inputs the second dataset for a distributed learning model, and restarts the learning.

It is preferable that the plurality of learning model processing devices that perform the distributed learning input the datasets for a distributed learning model into the learning model acquired from the learning model generation device and each derive a distributed-learning trained model, and any one of the learning model processing devices integrates a plurality of the distributed-learning trained models to derive the trained model.

Still another aspect of the present invention relates to a non-transitory computer readable medium for storing a computer-executable program, the computer-executable program causing a computer to function: a learning model transmission unit that receives transmission of an encrypted learning model from a learning model generation device and transmits a derived trained model to the learning model generation device; a data acquisition unit that acquires a dataset for a learning model; and a learning model training unit that trains the learning model by using the dataset for a learning model through confidential computation, to derive the trained model.

According to the aspects of the present invention, it is possible to perform, in a non-disclosed state, the machine learning on the learning model transmitted from a different device without taking out the data for a learning model.

### BRIEF DESCRIPTION OF THE DRAWINGS

FIG. 1 is a schematic diagram showing a remote learning system.

FIG. 2 is an explanatory diagram showing transmission and reception of data between a learning model generation device and a learning model processing device.

FIG. 3 is a block diagram showing a function of the learning model generation device.

FIG. 4 is a block diagram showing a function of the learning model processing device.

FIG. 5 is an explanatory diagram showing storage points provided in a learning model image.

FIG. 6 is a flowchart showing the series of flows in the learning model processing device, in which machine learning is performed on an acquired learning model and a derived trained model is transmitted to the learning model generation device.

FIG. 7 is a schematic diagram showing a remote learning system according to a second embodiment.

FIG. 8 is a schematic diagram of a remote learning system according to a third embodiment.

### DESCRIPTION OF THE PREFERRED EMBODIMENTS

### First Embodiment

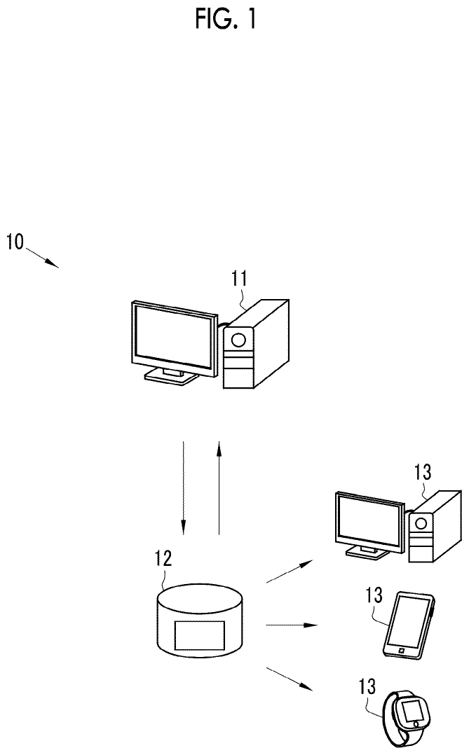

As shown in FIG. 1, a remote learning system 10 includes a learning model generation device 11 that generates a learning model, a learning model processing device 12 that performs machine learning on the learning model by using a dataset for a learning model, and a provider terminal 13 that receives notification from the learning model processing device 12.

The learning model generation device 11 is a device having a function of generating a learning model owned by a data user, such as a pharmaceutical company or a medical device manufacturer, and transmitting and receiving the learning model, and encrypts the generated learning model and sends the encrypted learning model to the learning model processing device 12 based on an instruction or an operation of the data user.

The learning model processing device 12 is a device that performs machine learning on the learning model by a data administrator, such as a health checkup facility or a medical institution, to derive a trained model, acquires the learning model by the transmission from the learning model generation device 11, and transmits the derived trained model to the learning model generation device 11. The machine learning on the learning model is performed without disclosing the learning model to the user or the administrator of the learning model processing device 12 by using a confidential computation unit implemented by the hardware encryption. In addition, a price of the trained model is calculated, and notification of a reward amount to a data provider based on the price is issued to a plurality of provider terminals 13.

The provider terminal 13 is an information terminal such as a personal computer (PC), a smartphone, or a wearable device to which a provider group that directly or indirectly provides each data for a learning model constituting the dataset for a learning model to the learning model processing device 12 can access. The provider terminal 13 may be an information terminal owned by an individual, or may be a medical information management device that is a server for managing pieces of health data of a plurality of persons provided in each medical institution or medical-related company, or a medical device that is a wearable device which measures and transmitting the health data and is lent to the provider by the medical institution or the like.

In the remote learning system 10, the machine learning is performed in a state in which the learning model generation device 11 does not disclose the learning model to the learning model processing device 12 and the learning model processing device 12 does not take out the dataset for a learning model.

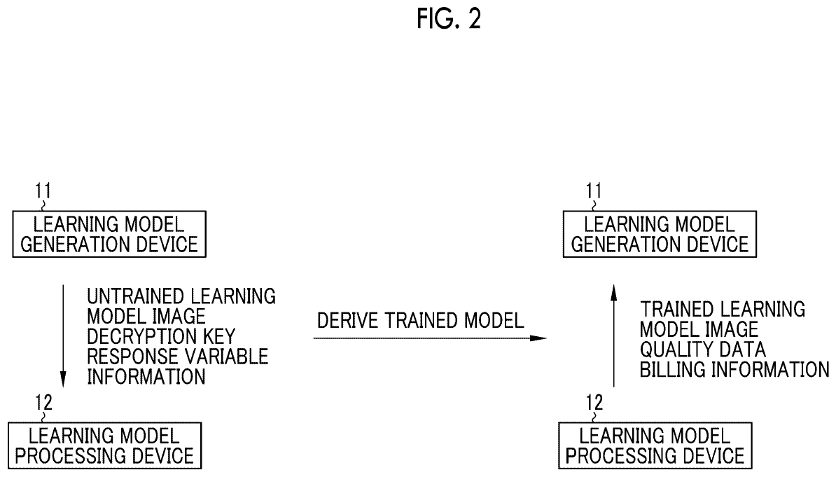

As shown in FIG. 2, in the remote learning system 10, the learning model processing device 12 receives the transmission of a decryption key, response variable information, and an encrypted untrained learning model image from the learning model generation device 11, and performs the machine learning for training using the dataset for a learning model acquired in advance. The dataset for a learning model used in the machine learning is divided into a training dataset and an evaluation dataset. The machine learning is performed for training learning model by using the training dataset through the confidential computation, and thus an encrypted trained model is derived. The untrained learning model image has a learning model that has not been trained.

After the trained model derivation, the learning model generation device 11 receives the transmission of quality data, billing information, and an encrypted trained learning model image from the learning model processing device 12. The quality data is generated by performing anonymization processing on an evaluation result acquired by inputting the evaluation dataset to the trained model by the learning model processing device 12. The billing information is information on a billing amount based on the price of the trained model to be paid by a user, and the price of the trained model is decided from the evaluation result.

In the remote learning system 10, the learning model generation device 11 and the learning model processing device 12 are connected according to representational state transfer (REST). That is, the learning model is transmitted on the web having a unified interface in which data formats are common, addressability in which all information has a unique identifier, connectivity in which a hyperlink is included in information to be communicated, and statelessness in which communication is completed for each communication.

The dataset for a learning model is data provided from a plurality of providers, and is used for the machine learning on the learning model. The provided data is, for example, medical data including personal information related to the health of the provider, such as personal health record (PHR) data. In this case, the trained model is a learning model that has trained by using the health-related data. The PHR data is data including at least any one of a result of a hospital examination or test, a prescription, a result of a regular health checkup, a past illness, an allergy, progress information related to pregnancy and childbirth, or vital data such as blood pressure and pulse measured at home.

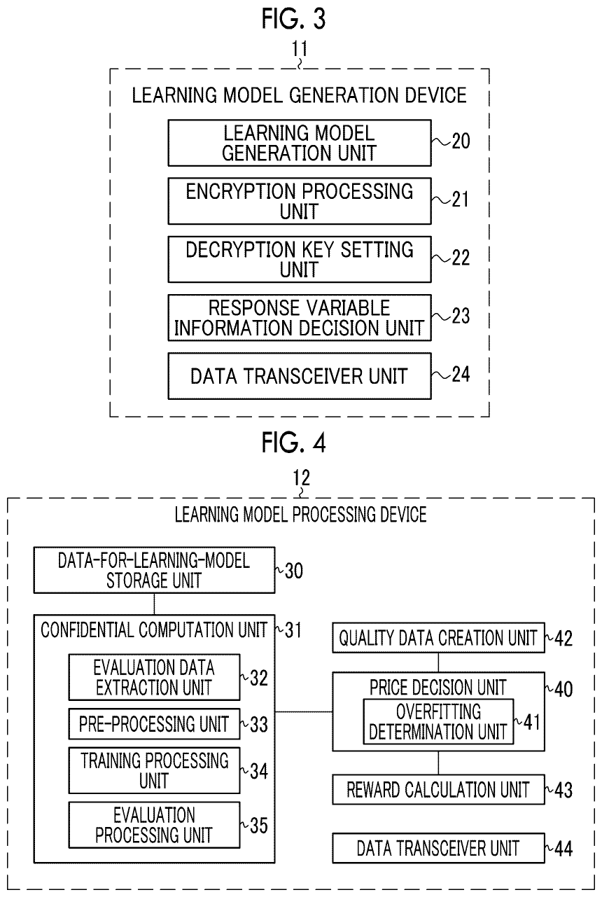

As shown in FIG. 3, in the learning model generation device 11, a program in a program memory is operated by a central controller (not shown) configured by a data control processor, and thus functions of a learning model generation unit 20, an encryption processing unit 21, a decryption key setting unit 22, a response variable information decision unit 23, a data transceiver unit 24, an input reception unit (not shown), and an output controller (not shown) are implemented. The input reception unit is connected to a user interface and receives the operation from the user.

The learning model generation device 11 is electrically connected to a display (not shown) and a user interface (UI) (not shown). The display displays a generation status of the learning model and information on the connected learning model processing device 12. The user interface is an input device for the user of the learning model generation device 11 to perform setting input for the learning model generation, input of the response variable information, or the like, and includes a keyboard, a mouse, and the like.

The learning model generation unit 20 generates a learning model on which pre-processing, learning model training processing (training processing), and learning model evaluation processing (evaluation processing) are to be performed. The learning model is represented in a form of a virtual machine (VM) image, a Docker image, or the like, and has a configuration of storing data to be input and data to be output in each processing. Further, the learning model comprises an interface that can activate the pre-processing, the training processing, and the evaluation processing from the outside.

In the pre-processing, the dataset for a learning model is read, and regularization for excluding an outlier is performed. The regularized dataset for a learning model is stored as a regularized training dataset and a regularized evaluation dataset. In the training processing, the regularized training dataset is read to perform the training. The trained model acquired by the training is stored. In the evaluation processing, the regularized evaluation dataset is read to evaluate the trained model. The evaluation result for the trained model is output and stored.

The encryption processing unit 21 encrypts a learning model image including the generated learning model. For the encryption, for example, a BitLocker method is used. In a Linux (registered trademark) environment, a method of Linux Unified Key Setup (LUKS) on disk format may be used.

The decryption key setting unit 22 sets the decryption key in a non-encrypted state for the encrypted learning model image. In addition, the learning model may be decrypted with stronger security by using a method of acquiring the decryption key from a URL set and managed by the data user, instead of transmitting the decryption key together with the learning model image.

The response variable information decision unit 23 implements a response variable input unit, receives the input from the user through the user interface, and decides the response variable information to be sent to the learning model processing device 12. The response variable information is information for designating a type of the health information included in the dataset for a learning model used to generate the trained model. The data user inputs “diabetes” which is a medical history, “a range or a threshold value of a blood pressure value” which is the health information, and the like. It should be noted that, instead of the input of the user through the user interface, the past response variable information or the like registered in advance may be used. The input of the response variable information requests learning using the dataset for a learning model having a case tendency value or a medical image equal to or larger than a threshold value set in advance for a specific disease.

The data transceiver unit 24 24 transmits the encrypted learning model image, the decryption key, and the response variable information to the learning model processing device 12. In addition, the trained learning model image, the quality data, and the billing information are acquired from the learning model processing device 12. The data transceiver unit 24 implements a learning model image transmission unit in the learning model generation device 11.

As shown in FIG. 4, in the learning model processing device 12, a program in a program memory is operated by a central controller (not shown) configured by a data control processor, and thus functions of a data-for-learning-model storage unit 30, a confidential computation unit 31, a price decision unit 40, a quality data creation unit 42, a reward calculation unit 43, and a data transceiver unit 44 are implemented. The confidential computation unit 31 includes an evaluation data extraction unit 32, a pre-processing unit 33, a training processing unit 34, and an evaluation processing unit 35. The price decision unit 40 includes an overfitting determination unit 41.

In addition, the learning model processing device 12 includes an output controller (not shown) that outputs data to a display that is an external device, and an input reception unit (not shown) that receives the input of a unit price of data in the price decision from the user interface (UI) that is an input device. The output controller stores a program related to processing such as image processing in a program memory (not shown), and displays a learning status of the learning model or the like on an electrically connected display as necessary.

The data-for-learning-model storage unit 30 comprises a storage memory (not shown) and stores the dataset for a learning model used in the confidential computation unit 31. As the dataset for a learning model, pieces of the data for a learning model of the plurality of providers are collected in advance. The collection may be performed by acquiring the data from the provider terminal 13 or may be performed by collecting the data through the medical institution or the like.

The confidential computation unit 31 implements a confidential computation unit and is implemented on a confidential virtual machine (CVM) in which the memory is protected such that data cannot be confirmed from the outside by using hardware encryption processing. Since the data on the confidential computation unit 31 is also protected from the user or the administrator of the learning model processing device 12, the machine learning can be performed in a state in which the configuration of the learning model encrypted by using the decryption key is not disclosed. The confidential computation unit 31 performs the same encryption in a case in which the learning model image is transmitted to the learning model generation device 11, in response to the encryption used by the learning model generation device 11. A data acquisition unit is implemented, and the dataset for a learning model stored in the data-for-learning-model storage unit 30 is acquired.

The evaluation data extraction unit 32 implements an evaluation data extraction unit, and performs extraction processing of dividing the acquired datasets for a learning model, such that a specific ratio is obtained, into the training dataset used for the training and the evaluation dataset used to evaluate the trained model, and extracting an evaluation dataset that is not used for the training. It is preferable that the extraction processing is performed at a timing at which the learning model and the response variable information are acquired from the learning model generation device 11. In addition, for the cross-validation, a plurality of training datasets and a plurality of evaluation datasets may be generated by K-fold cross-validation.

The pre-processing unit 33 implements a pre-processing unit and has a function of performing pre-processing. In the pre-processing, the training dataset and the evaluation dataset obtained in the evaluation data extraction unit 32 are subjected to the pre-processing including the regularization. Data of the outlier in the training dataset and the evaluation dataset can be excluded by the regularization. A pre-processed training dataset and a pre-processed evaluation dataset are obtained by the pre-processing unit.

The training processing unit 34 implements a learning model training unit and has a function of performing the training processing on the learning model. In the training processing, the learning is performed on the learning model having the untrained learning model image by using the pre-processed training dataset, to generate the trained model. The trained model has a function of discriminating an item input to the response variable information by the machine learning.

The evaluation processing unit 35 implements a learning model evaluation unit, inputs the pre-processed evaluation dataset to the trained model, and performs the evaluation processing of outputting the evaluation result. The evaluation result is represented by an area-under-the-curve (AUC) value of 0 to 1.0. The AUC value is a value indicating the discrimination ability of discriminating the response variable information of the trained model, and the discrimination ability is higher as the value is closer to 1.0, and there is no discrimination ability in the AUC value of around 0.5, for example, 0.4 to 0.6. The AUC value indicates 0.5 in a case in which the discrimination ability is random. Therefore, it can be discriminated that the trained model has significant discrimination ability in a case in which the AUC value is at least a value larger than 0.6. Even in a case in which the AUC value is less than 0.4, for example, in a case in which the AUC value is 0.1 or less, the determination result need only be inverted, and it can be discriminated that the discrimination ability is high.

In addition, the pre-processed evaluation dataset may be input to the learning model during the training processing, which has temporarily stopped the training processing stopped, to acquire a training-time evaluation result. The training-time evaluation result indicates accuracy during the training.

The evaluation processing is also affected by a quality of the learning model image created by the data user, in addition to the dataset for a learning model. Therefore, even in a case in which it is evaluated that the discrimination ability is not present in the evaluation processing and the training is performed again by using a different dataset for a learning model, an upper limit of the number of times of the repetition of the training is set. For example, the number of times that the training can be repeated is set to two, and the training is not repeated after the third evaluation processing. A variation degree of the AUC values acquired a plurality of times can also be evaluated as the quality of the data.

The price decision unit 40 implements a price decision unit, acquires the evaluation result from the evaluation processing unit 35, and decides the price of the trained model based on the evaluation result. The billing amount, which is the total amount to be paid by the data user such as an operator of the learning model generation device 11, is calculated based on the decided price. The price is decided based on the configuration of the dataset for a learning model in addition to the evaluation result. For example, the decision is made according to the evaluation result, the unit price based on the type of the data included in the dataset for a learning model, and the total number of pieces of data in the dataset for a learning model.

The overfitting determination unit 41 implements an overfitting determination unit, and calculates an overfitting degree in a case in which the training processing in the training processing unit 34 is temporarily stopped and the training-time evaluation result indicating the accuracy during the training is acquired in the evaluation processing unit 35. The overfitting degree is a value calculated based on a deviation amount between the training-time evaluation result and the evaluation result, and the price decision unit 40 reduces the billing amount according to the overfitting degree. The overfitting may occur, for example, in a case in which the training data to be input is biased, in a case in which the training data is further input after sufficient learning, and in a case in which a large amount of inappropriate training data is included.

In the determination of the overfitting, for example, an evaluation value and information on the number of pieces of input evaluation data are acquired in each of the training-time evaluation result and the evaluation result, a relationship between the number of pieces of input training data and the evaluation values during the temporary stop and during the training processing is compared, and an increase rate of the evaluation value with respect to an increase rate of the number of pieces of training data is obtained. As the increase rate of the evaluation value with respect to the increase rate of the number of pieces of training data more deviates from a specific appropriate range, the overfitting degree is higher, and it can be determined that the learning performed by inputting the evaluation data is not appropriately performed.

The quality data creation unit 42 implements an evaluation data providing unit and creates the quality data by processing the regularized evaluation dataset. The evaluation dataset has personal information or the like and cannot be transmitted from the learning model processing device 12 to the learning model generation device 11, so that a part corresponding to the personal information is processed by replacement processing or mask processing to be processed into a transmittable state. On the other hand, in the quality data obtained by the processing, the presence or absence of the item related to the response variable information included in the evaluation dataset can be recognized. As a result, the data user can check the quality of the trained model with reference to the quality data.

The quality data creation unit 42 may include the evaluation result. In this case, it is preferable to add an explanation to the data user regarding the discrimination ability indicated by the AUC value which is the evaluation result. For example, the discrimination ability according to the AUC value is evaluated in stages.

The reward calculation unit 43 implements an individual reward amount calculation unit and calculates the reward amount to be paid to the provider of each data constituting the dataset for a learning model from a total reward amount based on the price of the trained model. The information on the provider is used, which is stored in the data-for-learning-model storage unit 30 in association with the corresponding data for a learning model for each provider. The grouping and the ratio calculation are performed to decide an individual reward, which is the reward amount to be paid, for each provider. Since the data for a learning model is one data per person, the total number of records of the data for a learning model constituting the dataset for a learning model is the number of people to whom the reward is paid.

In the grouping, the providers of the data used for the learning are grouped according to the response variable information that is acquired from the learning model generation device 11 and that designates the type of the data for a learning model or the type of the data included in the data for a learning model. In a case in which the response variable information is one item, the group is divided into a group having data corresponding to the response variable information and a group having no data corresponding to the response variable information. In addition, in a case in which there are a plurality of items of the response variable information, the group is set for each corresponding number.

In the ratio calculation, the reward amount to be paid to the provider of the data that matches the type of data indicated by the response variable information in combination with the grouping is set to be higher than the reward amount to be paid to the provider of the data that does not match the type of data. For example, the total reward amount is equally divided by the number of groups, the reward amount for each group is set to be equal, and a value obtained by equally dividing the reward amount for each group in each group by the number of people belonging to the group is set as the individual reward. As a result, the provider belonging to the group with a small number of people receives the individual reward with a higher reward amount than the providers in other groups.

The decided reward amount and the response variable information are presented to the provider. The reward amount to be paid to the individual varies depending on the content of the provided data. In the grouping, a provider of valuable data can also obtain a high individual reward by grouping the valuable data or the like that does not correspond to the response variable information for designating the data desired for the learning by the user. The valuable data is data of a provider having a disease, data of a provider having a rare blood type, or the like.

The data transceiver unit 44 implements a learning model transmission unit, and transmits the trained learning model image, the quality data, and the billing information to the learning model generation device 11. The encrypted learning model image, the decryption key, and the response variable information may be acquired from the learning model processing device 12. The data transceiver unit 44 implements a learning model image transmission unit in the learning model processing device 12. In addition, as a response variable disclosure unit, the response variable information is presented to the provider terminal 13 together with the calculated reward amount.

An example of the remote learning system 10 will be described in which the LUKS is used as the encryption method of the learning model, the response variable information is “hypertension”, and the machine learning using the PHR data.

The generation of the learning model image is performed at a data use base that is the pharmaceutical company or the medical device manufacturer having the learning model generation device 11, and the machine learning using the PHR data is performed at a PHR data base that is the medical institution having the learning model processing device 12 and holding the PHR data collected from the plurality of providers. In addition, the learning model processing device 12 implements the function of the confidential computation unit 31 by using a second generation AMD EPYC processor (manufactured by Advanced Micro Devices, Inc.) having a “Secure Encrypted Virtualization” function.

The learning model generation device 11 encrypts a partition and the following partitions by applying the LUKS to the learning model image, which is the VM image generated by the learning model generation unit 20, by the encryption processing unit 21. The learning model image has a route partition in which each processing of the machine learning can be performed in the learning model processing device 12. The decryption key setting unit 22 sets a non-encrypted partition for activating the machine learning of the learning model processing device 12 in the VM image. The learning model comprises a network file system (NFS) mount point for reading the PHR data for the training dataset and the evaluation dataset.

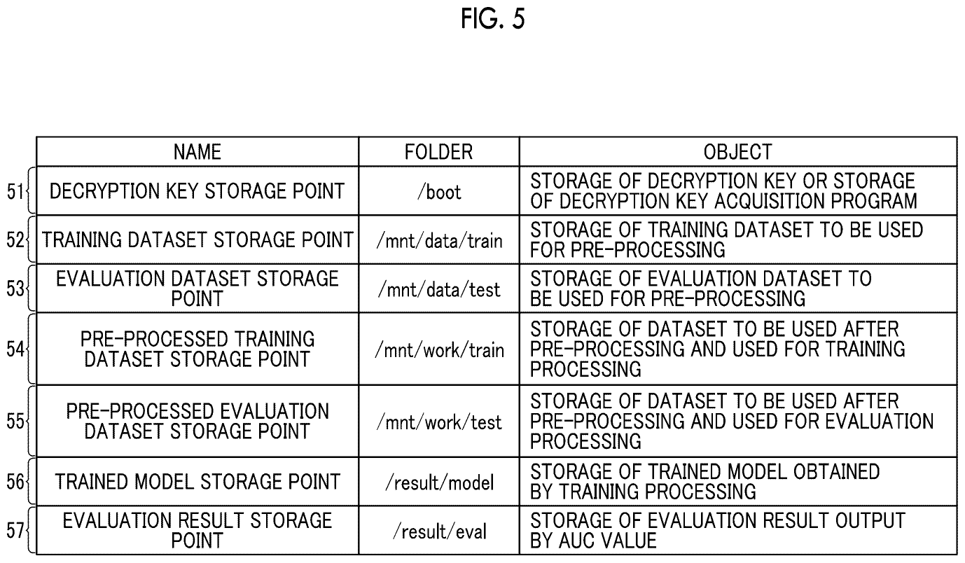

As shown in FIG. 5, the learning model image generated by the learning model generation unit 20 comprises, as folders used for input or output in each processing of the machine learning performed by the learning model processing device 12, a decryption key storage point 51, a training dataset storage point 52, an evaluation dataset storage point 53, a pre-processed training dataset storage point 54, a pre-processed evaluation dataset storage point 55, a trained model storage point 56, and an evaluation result storage point 57. It is preferable that the folder as each storage point is set to be read-only or to be read/write according to the role.

The decryption key storage point 51 is a folder assigned to “/boot” and stores the decryption key set by the decryption key setting unit 22. The decryption key storage point 51 is the non-encrypted partition, and uses the decryption key to decrypt the encrypted learning model image by using the decryption key in the confidential computation unit 31, to start the machine learning. Instead of the decryption key, a decryption key acquisition program may be set, and the decryption key may be acquired from a uniform resource locator (URL) for decryption managed by the data user by performing the decryption key acquisition program.

The training dataset storage point 52 is a folder assigned to “/mnt/data/train” and stores the training dataset divided from the dataset for a learning model. The training dataset is used for the pre-processing.

The evaluation dataset storage point 53 is a folder assigned to “/mnt/data/test” and stores the evaluation dataset divided from the dataset for a learning model. The evaluation dataset is used for the pre-processing.

The pre-processed training dataset storage point 54 is a folder assigned to “/mnt/work/train” and stores the pre-processed training dataset which is the training dataset output by the pre-processing. The pre-processed training dataset is used for the training processing.

The pre-processed evaluation dataset storage point 55 is a folder assigned to “/mnt/work/test” and stores the pre-processed evaluation dataset which is the evaluation dataset output by the pre-processing. The pre-processed training dataset is used in the evaluation processing.

The trained model storage point 56 is a folder assigned to “/result/model” and stores the trained model output by the training processing. The trained model is used for evaluation processing and is transmitted to the learning model generation device 11 after the evaluation processing.

The evaluation result storage point 57 is a folder assigned to “result/eval” and stores the evaluation result output by the evaluation processing. The evaluation result is represented by the AUC value.

In addition, the learning model image comprises a REST-API, which is an application programming interface (API) corresponding to REST, as an interface that performs the pre-processing, the training processing, and the evaluation processing in response to the request in the confidential computation unit 31. The REST-API has a URL path for starting each processing in response to an HTTP operation by the confidential computation unit 31. The URL path is, for example, “/preproc” in the pre-processing, “/train” in the training processing, and “/eval” in the evaluation processing. Each URL path is designated in a GET request which is an HTTP verb and is issued by the confidential computation unit 31, and each processing is started in response to the request.

The encryption processing unit 21 performs the encryption processing on the generated learning model image and protects the data of the learning model image until the learning model image is decrypted by the confidential computation unit 31 of the learning model processing device 12 through the confidential computation. The decryption key setting unit 22 sets the decryption key in a non-encrypted state.

Since the purpose is the trained model that has been trained on hypertension, the response variable information decision unit 23 inputs blood pressure information as the response variable information through the user interface. As a reference value for discriminating hypertension, a systolic blood pressure is input as 130 mmHg or more, and a diastolic blood pressure is input as 80 mmHg or more.

The transmission data including at least a re-encrypted trained model image, the decryption key, and the response variable information is transmitted via the data transceiver unit 44. The transmission and reception of the learning model image between the learning model generation device 11 and the learning model processing device 12 are implemented as a general web application. The data user transmits the URL to the learning model processing device 12 to perform the data transmission while maintaining the security.

In a case in which the untrained learning model image is transmitted from the learning model generation device 11 to the learning model processing device 12, for example, a URL set to “https://data_base_host/learning” is transmitted to the learning model processing device 12, and the learning model processing device 12 accesses the URL to acquire the encrypted untrained learning model image. It should be noted that the data handled by a data base host is the PHR data or the like.

In the transmission of the trained model from the learning model processing device 12 to the learning model generation device 11, for example, a URL set as “https://data_base_host/learned” is transmitted to the learning model generation device 11, and the data user accesses this URL to acquire the trained learning model image.

The confidential computation unit 31 that activates the CVM and acquires the untrained learning model image stores the PHR data as an NFS server. The confidential computation unit 31 that stores the datasets for a learning model of a sufficient number of people divides the dataset for a learning model collected from the provider terminal 13 in the evaluation data extraction unit 32. For example, pieces of the PHR data of 1,000 people are used as the datasets for a learning model of a sufficient number of people. In the division, in order to avoid overfitting for a specific item in the training dataset and the evaluation dataset and to perform the training and the evaluation with random PHR data, the data is shuffled. The shuffled PHR data is divided into the training dataset and the evaluation dataset in a ratio of 7:3. The evaluation dataset extracted by the division is stored in the evaluation dataset storage point 53.

After the extraction processing, the untrained learning model image is decrypted by using the decryption key in the CVM in which the memory is protected by the hardware encryption. By performing the decryption in the CVM, the training processing or the evaluation processing on the learning model image can be performed in a state of not being disclosed to the operator or the administrator of the learning model processing device 12.

After the decryption, the training processing unit 34 issues an HTTP GET request for the pre-processing on the learning model image. The learning model image returns HTTP 200, which is a status code indicating “OK”, to the training processing unit 34 in response to the GET request, and performs the pre-processing on the training dataset stored in the training dataset storage point 52 and the evaluation dataset stored in the evaluation dataset storage point 53. The pre-processed training dataset and the pre-processed evaluation dataset obtained by the pre-processing are stored in the pre-processed training dataset storage point 54 and the pre-processed evaluation dataset storage point 55. In the regularization in the pre-processing, the outlier and the like are excluded.

After the pre-processing, the training processing unit 34 issues an HTTP GET request for the training processing to the learning model image. The learning model image returns the HTTP 200 to the training processing unit 34 in response to the GET request, and performs the training processing by using the pre-processed training dataset stored in the pre-processed training dataset storage point 54 to generate the trained model. The trained model is stored in the trained model storage point 56.

After the training processing, the evaluation processing unit 35 issues the HTTP GET request for the evaluation processing on the learning model image. The learning model image returns the HTTP 200 to the evaluation processing unit 35 in response to the GET request, performs the evaluation processing on the trained model stored in the trained model storage point 56 by using the pre-processed evaluation dataset, and outputs the evaluation result. The AUC value obtained as the evaluation result is also output as an HTTP response. The AUC value is stored in the evaluation result storage point 57.

After the evaluation processing, the re-encryption processing and the decryption key setting are performed on the learning model image in which the trained model is stored, and the learning model image is transmitted from the confidential computation unit 31 to the data transceiver unit 44.

After each processing in the confidential computation unit 31 ends, the price decision unit 40 decides the price of the trained model image by using the total number of PHR data records, which is the total number of datasets for a learning model, and the evaluation result. The decided price is a billing amount to be billed for the data user. The price is decided based on a degree of the discrimination ability of the trained model, the unit price of the PHR data, and the total number of PHR records. For example, the price is obtained by calculating (AUC value−0.5)×unit price of PHR data×total number of PHR data records.

After the price decision, the quality data creation unit 42 creates the quality data from the evaluation result and the evaluation dataset. The processing, such as deletion, pseudonymization, and anonymization of data, is performed on the evaluation dataset such that the processed data can be output from the learning model processing device 12 to the learning model generation device 11. For example, information that does not affect the evaluation may be deleted, the information may be pseudonymized or anonymized, such as noise processing of partial information, or the blood pressure information, which is the response variable information, may be processed to be converted into an approximate value represented by 5 mmHg. An explanation regarding a degree of the quality indicated by the AUC value is added to the evaluation result.

After the quality data creation, the quality data, the billing amount based on the price, and the re-encrypted learning model image are sent to the learning model generation device 11 via the data transceiver unit 44.

After the price decision, the reward calculation unit 43 calculates the reward amount to be paid, for each provider of the data for a learning model, based on the price. The individual reward amount is an amount obtained by equally dividing the total reward amount, which is divided by the number of groups, by the number of people in the group to which the individual belongs. Therefore, the calculation of the reward amount is performed by the grouping and the ratio calculation. In the grouping, two groups are decided based on whether or not the PHR data corresponds to hypertension, which is the response variable information, and each PHR data is grouped. In the ratio calculation, an equal reward amount is assigned to each of a group having hypertension and a group having no hypertension, and a value obtained by dividing the equal reward amount by the number of people in each group is obtained. For example, in a case in which there are 1,000 providers of the PHR record data and there are 200 persons having hypertension among the 1,000 providers, the individual reward of the person having hypertension is (total reward amount/2)/200. In addition, the individual reward of the person who does not have hypertension is (total reward amount/2)/800.

After the reward calculation, the notification of the individual reward amount calculated via the data transceiver unit 44 and the response variable information are issued to the provider terminal 13 owned by each provider. As a result, each provider can specifically understand how the PHR data of the provider is used for what purpose or reason.

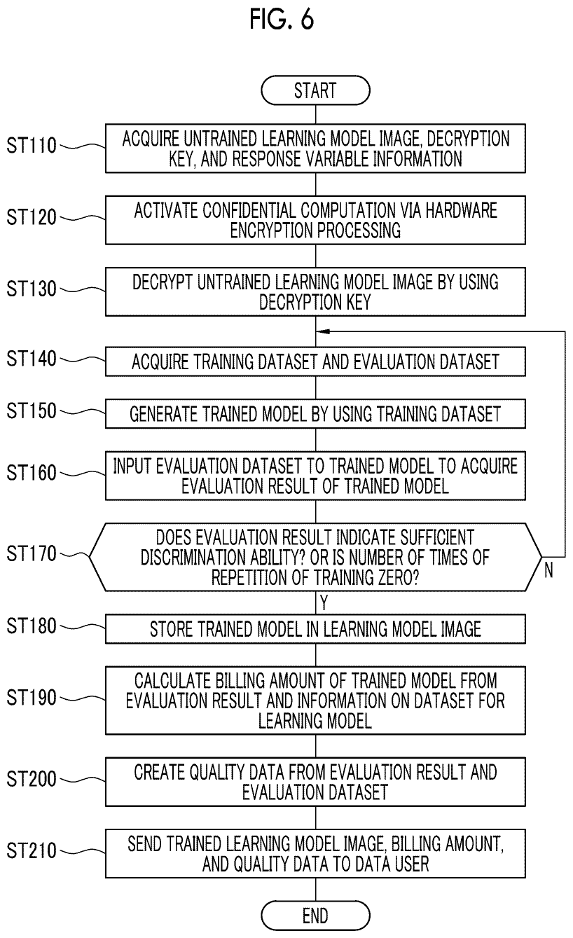

As shown in FIG. 6, a flowchart showing the series of flows in which the learning model processing device 12 does not take out the data for a learning model and performs the machine learning on the learning model transmitted from a different device in a non-disclosed state will be described. The learning model processing device 12 acquires the encrypted untrained learning model image, the decryption key, and the response variable information from the learning model generation device 11 (step ST110). In the confidential computation unit 31 that acquires the untrained learning model image, the hardware encryption processing is performed to activate the CVM that is the confidential computation machine (step ST120). The confidential computation unit 31 acquires the decryption key, decrypts the encrypted untrained learning model image, and acquires the untrained learning model image on which the pre-processing, the training processing, and the evaluation processing can be performed (step ST130).

The evaluation data extraction unit 32 acquires the dataset for a learning model stored in advance in the data-for-learning-model storage unit 30, and divides the dataset for a learning model into the training dataset and the evaluation dataset (step ST140). The training processing unit 34 performs the training processing by using the training dataset regularized by the pre-processing by the pre-processing unit 33, to generate the trained model (step ST150). The evaluation processing unit 35 performs the evaluation processing on the generated trained model by using the evaluation dataset regularized to the pre-processing in the pre-processing unit 33, to acquire the evaluation result of the trained model (step ST160). In a case in which the discrimination ability of the trained model is not sufficient, such as a case in which the evaluation result evaluated by the AUC value is a value of 0.4 to 0.6 or the like, and the number of times that the training can be repeated is one or more (N in step ST170), the dataset for a learning model is acquired again from the data-for-learning-model storage unit 30, and the trained model is generated by dividing the dataset for a learning model into the training dataset and the evaluation dataset (step ST140).

In a case in which the discrimination ability of the trained model is sufficient, such as a case in which the evaluation result is a value larger than 0.6, or in a case in which the number of times that the training can be repeated is 0 (Y in step ST170), the trained model is stored in the learning model image (step ST180). After the storage, the price decision unit 40 calculates the billing amount for the trained model to be billed to the data user based on the evaluation result, the unit price of the data for a learning model, and the number of datasets for a learning model (step ST190). The quality data creation unit 42 creates the quality data to be sent to the data user by performing the anonymization such as editing for the evaluation result and noise removal for the evaluation dataset (step ST200). The trained model, the billing amount, and the quality data generated in the learning model processing device 12 are sent to the learning model generation device 11 (step ST210).

With the above-described content, in the generation of the trained model, the learning model generation device 11 can perform the training without disclosing the learning model image to the learning model processing device 12. In addition, the learning model processing device 12 can train the learning model image generated by another device without outputting the dataset for a learning model having the personal information.

In addition, in the first embodiment, the trained model is generated by the machine learning performed by one learning model processing device 12 on the learning model image acquired from the learning model generation device 11, but distributed learning may be performed in which the machine learning on the learning model image is distributed and performed by a plurality of learning model processing devices to generate the trained model.

The remote learning system that performs the distributed learning includes the learning model generation device 11 and the plurality of learning model processing devices that perform the distributed learning on the untrained learning model image generated and encrypted by the learning model generation device 11. In this case, the datasets for a learning model are distributed and held in the plurality of learning model processing devices as different datasets for a distributed learning model. The learning model processing devices perform the distributed learning using the confidential computation unit on the learning model image, which is generated and encrypted by the learning model generation device 11, by using the datasets for a distributed learning model held in the respective learning model processing devices. The learning model generation device 11 receives the input of the learning model image having the trained model derived by the distributed learning. A second embodiment and a third embodiment are embodiments in which the trained model is derived by distributed learning.

### Second Embodiment

In a remote learning system according to the second embodiment, one learning model image is transmitted in order to the plurality of learning model processing devices, and the confidential computation of the distributed learning in which the learning is repeated is performed. Each learning model processing device transmits an in-middle-of-learning model derived by using the dataset for a distributed learning model, which is the dataset for a learning model, to a next base and restarts the learning on the transmitted in-middle-of-learning model. It should be noted that descriptions of other contents that are the same as those of the first embodiment will not be repeated.

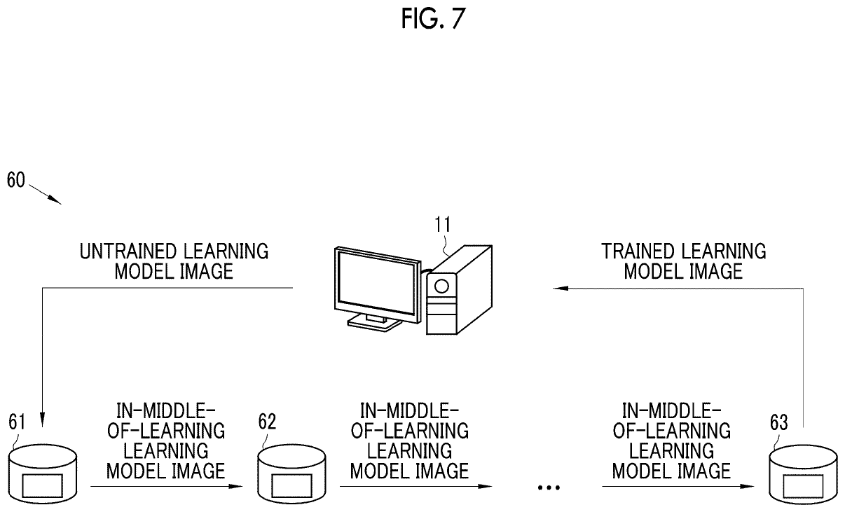

As shown in FIG. 7, a remote learning system 60 that implements a distributed learning unit comprises the learning model generation device 11, and a first learning model processing device 61 that derives the in-middle-of-learning model by performing first distributed learning, a second learning model processing device 62 that performs the distributed learning on the in-middle-of-learning model, and a third learning model processing device 63 that derives the trained model by performing the last distributed learning, as a plurality of learning model processing devices. The learning model image in which the in-middle-of-learning model is stored is encrypted as an in-middle-of-learning learning model image and is transmitted.

The second learning model processing device 62 is included in the remote learning system 60 in a number corresponding to the number of times of the distributed learning until the trained model is derived. That is, in the distributed learning in which the distributed learning is performed by being distributed in n places (n ≥2), the distributed learning is performed in the second learning model processing device 62 in n−2 places. In the distributed learning using the datasets for a learning model distributed to two places, the distributed learning is performed by the first learning model processing device 61 and the third learning model processing device 63.

The first learning model processing device 61, the second learning model processing device 62, and the third learning model processing device 63 have a function of acquiring input/output information which is information on an input destination and an output destination of the learning model image, and a function of controlling the distributed learning, in addition to each function of the learning model processing device 12 (see FIG. 4). The input/output information is information for recognizing whether the learning model generation device 11 or the learning model processing device is used.

In the input/output information in the first learning model processing device 61, an input source is the learning model generation device 11 and a transmission destination is a learning model processing device which is the second learning model processing device 62 or the third learning model processing device 63. The first learning model processing device 61 performs stop processing of stopping the training processing of the untrained learning model image via the training processing unit 34 in a state in the middle of learning in which the learning can be restarted, and transmission processing of transmitting the learning model image in a state in the middle of learning to another learning model processing device that has not performed the machine learning.

In the input/output information in the second learning model processing device 62, the input source is a learning model processing device which is the first learning model processing device 61 or the second learning model processing device 62 that has performed the distributed learning, and the transmission destination is a learning model processing device which is the second learning model processing device 62 or the third learning model processing device 63 that has not performed the distributed learning. The second learning model processing device 62 receives the transmission of the learning model image in which the in-middle-of-learning model is stored, and performs the restart processing of restarting the training processing on the in-middle-of-learning model. In addition, the training processing unit 34 performs the stop processing of stopping the training processing via the training processing unit 34 in a state in the middle of learning in which the learning can be restarted, and the transmission processing of transmitting the learning model image in a state in the middle of learning to another learning model processing device that has not performed the machine learning.

In the input/output information in the third learning model processing device 63, the input source is a learning model processing device which is the first learning model processing device 61 or the second learning model processing device 62, and the transmission destination is the learning model generation device 11. The third learning model processing device 63 receives the transmission of the learning model image in which the in-middle-of-learning model is stored, and performs the restart processing of restarting the training processing on the in-middle-of-learning model. The training processing unit completes the restarted training processing and acquires the trained model.

Since the price calculation for the derived trained model in the third learning model processing device 63 uses the information on the total number of records and the unit price of the dataset for a learning model, the information necessary for the price decision in the dataset for a distributed learning model of each of the first learning model processing device 61 and the second learning model processing device 62, which have performed the distributed learning, is acquired. For example, the first learning model processing device 61 and the second learning model processing device output the price calculation information generated by performing the anonymization or the deletion of the unnecessary information on the personal information included in the dataset for a distributed learning model to the learning model processing device as the output destination together with the learning model image having the in-middle-of-learning model. The generated price calculation information may be directly transmitted to the third learning model processing device 63.

The reward amount calculated in the third learning model processing device 63 is transmitted to the first learning model processing device 61 and the second learning model processing device 62 that have performed the distributed learning, based on the acquired price calculation information. As a result, each learning model processing device can notify the provider terminal of the information on the reward amount.

The first learning model processing device 61 and the second learning model processing device 62 may perform the training processing by using the entire dataset for a learning model as the training dataset without performing the extraction processing and the evaluation processing. In this case, the evaluation processing is performed only by the third learning model processing device 63.

As an example in the second embodiment, the remote learning system 60 will be described, which performs the distributed learning by using three learning model processing devices. For example, the respective devices provided in the remote learning system 60 belong to bases different from each other, transmit the learning model image at a learning model use base including the learning model generation device 11, a first training base to which the first learning model processing device 61 that holds a first dataset for a distributed learning model belongs, a second training base to which the second learning model processing device 62 that holds a second dataset for a distributed learning model belongs, and a third training base including the third learning model processing device 63, and derive the trained model.

The first learning model processing device 61 inputs a first distributed training dataset divided from the first dataset for a distributed learning model to the untrained learning model image acquired from the learning model generation device 11, and derives the in-middle-of-learning model that has stopped learning in a state in the middle of learning. The in-middle-of-learning model is stored in the learning model image. The in-middle-of-learning learning model image, which is the learning model image in which the in-middle-of-learning model is stored, is encrypted and transmitted to the second learning model processing device 62 together with the price calculation information.

The second learning model processing device 62 acquires the learning model image having the in-middle-of-learning model transmitted from the first learning model processing device 61, inputs a second distributed training dataset divided from the second dataset for a distributed learning model, and restarts the learning.

The in-middle-of-learning model in the distribution processing is stored in an in-middle-of-learning model storage point different from the trained model storage point 56 in the learning model image. The in-middle-of-learning model storage point is a folder assigned to “/middle/model” and stores the in-middle-of-learning model output by the training processing. The learning model image in which the in-middle-of-learning model stopped in the middle of the learning is stored is subjected to the re-encryption processing and is transmitted to the second learning model processing device 62 or the third learning model processing device 63 in a state in which the training processing can be restarted.

In the restart of the training processing, the training processing of inputting the dataset for a learning model, which is held for each learning model processing device, to the in-middle-of-learning model stored in the in-middle-of-learning model storage point is performed. The second learning model processing device 62 derives the in-middle-of-learning model that has stopped in the middle of learning again, and the third learning model processing device 63 derives the trained model.

As a result, even in a case in which the learning model is held at a plurality of bases or in the plurality of learning model processing devices, it is possible to perform the machine learning on the learning model generated by another device without outputting the dataset for a learning model held by each base or device. By performing the distributed learning, it is possible to perform the machine learning with a sufficient amount of data even in a case in which the number of pieces of data in the dataset for a learning model included in each learning model processing device is small.

### Third Embodiment

In a remote learning system according to the third embodiment, as the distributed learning, ensemble learning of a stacking method of collecting a plurality of individually derived trained models in one place and integrating the plurality of trained models into one trained model is performed. The respective learning model processing devices hold different ensemble learning datasets which are the datasets for a distributed learning model, and derive the trained model by using the ensemble learning dataset. It should be noted that descriptions of other contents that are the same as those of the first embodiment and the second embodiment will not be repeated.

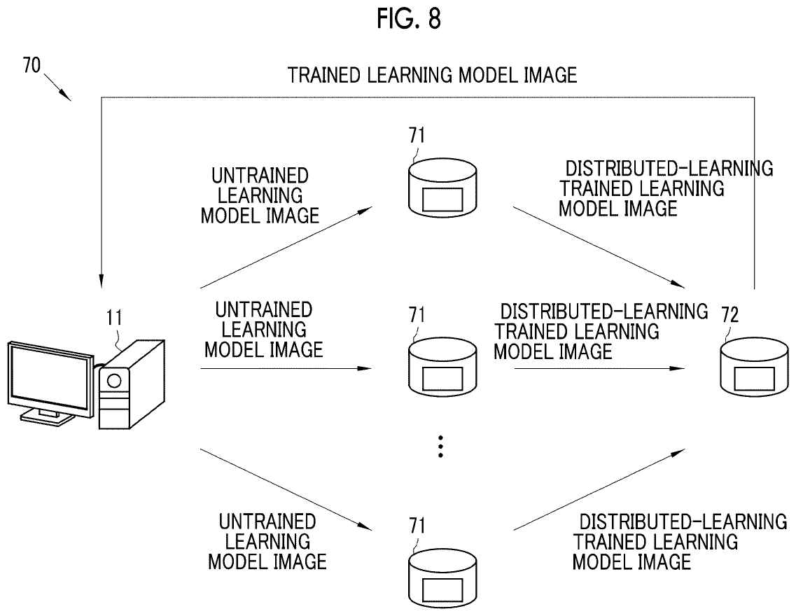

As shown in FIG. 8, a remote learning system 70 that implements a distributed learning unit comprises the learning model generation device 11, a plurality of fourth learning model processing devices 71 that derive distributed-learning trained models through the machine learning using the untrained learning model image, and a fifth learning model processing device 72 that integrates the respective distributed-learning trained models transmitted from the plurality of fourth learning model processing devices 71 into one trained model.

The fifth learning model processing device 72 has a function of performing integration processing via the confidential computation in addition to the same function as the fourth learning model processing device 71, integrates the trained models stored in the distributed-learning trained model images into one trained model, stores the integrated trained model in the learning model image, and transmits the encrypted trained learning model image to the learning model generation device 11.

In addition, the fifth learning model processing device 72 may also acquire the untrained learning model image transmitted from the learning model generation device 11 and derive the distributed-learning trained model. In this case, the fourth learning model processing device 71 performs the distributed learning in at least one place.

As an example of the remote learning system 70 according to the third embodiment, the distributed learning will be described in which the ensemble learning dataset, which is the dataset for a distributed learning model, is input to the untrained learning model image acquired from the learning model generation device 11 at four different bases. Each learning model processing device that receives the input of the ensemble learning dataset derives the distributed-learning trained model, and the learning model processing device at any one base integrates the distributed-learning trained models to derive one trained model. Each base comprises the learning model processing device, and any base that integrates the trained model includes the fifth learning model processing device 72, and the other base includes the fourth learning model processing device 71.

For example, the remote learning system 70 transmits the learning model image between the learning model use base at which the learning model is generated, a first ensemble learning base at which the machine learning using a first ensemble learning dataset is performed, a second ensemble learning base at which the machine learning using a second ensemble learning dataset is performed, a third ensemble learning base at which the machine learning using a third ensemble learning dataset is performed, and a trained model integration base at which the trained models derived at the first to third ensemble learning bases are integrated into one, and performs the distributed learning. It should be noted that, in any transmission, the encryption processing and the decryption key setting have a different configuration each time.

At the learning model use base, the untrained learning model image is generated by the learning model generation device 11, and the response variable information, the decryption key, and the encrypted untrained learning model image are transmitted to the fourth learning model processing device 71 at the first to third ensemble learning bases.

At each ensemble learning base, the extraction processing, the pre-processing, the training processing, and the evaluation processing are performed on the untrained learning model image acquired in the fourth learning model processing device 71, to derive the trained model and the evaluation result. The trained model is stored at the trained model storage point 56 in the learning model image, is encrypted as the distributed-learning trained model image, and is transmitted to the trained model integration base.

At the trained model integration base, the confidential computation unit of the fifth learning model processing device 72 performs the integration processing of the generated trained model and the trained model extracted from each transmitted distributed-learning trained model image. The evaluation processing is performed on the trained model derived by the integration processing, the trained model for which the evaluation result is obtained is stored in the learning model image and is transmitted to the learning model generation device 11.

As described above, the trained model having high accuracy can be derived by generating the two-stage trained model. In addition, a highly versatile trained model can be derived by using sufficient data for generating the trained model, which is collected from the provider by each base.

In the machine learning at each ensemble learning base in the above-described examples, datasets for an ensemble learning model are divided into an ensemble training dataset and an evaluation dataset by the extraction processing, the pre-processing is performed as in the first embodiment, and then the training processing and the evaluation processing are performed. On the other hand, similarly to the second embodiment, the extraction processing and the evaluation processing need not be performed, and each dataset for an ensemble learning model may be used as the ensemble training dataset in the training processing.

In each of the embodiments described above, the hardware structures of the processing units that perform various types of processing, such as the central controller, the input reception unit, the output controller, the learning model generation unit 20, the encryption processing unit 21, the decryption key setting unit 22, the response variable information decision unit 23, and the data transceiver unit 24 in the learning model generation device, and the central controller, the input reception unit, the output controller, the confidential computation unit 31, the price decision unit 40, the quality data creation unit 42, the reward calculation unit 43, and the data transceiver unit 44 in the learning model processing device, are various processors as shown below. Examples of the various processors include a central processing unit (CPU) as a general-purpose processor that performs software (program) to function as various processing units, a programmable logic device (PLD) as a processor of which a circuit configuration can be changed after manufacturing, such as a field programmable gate array (FPGA), and a dedicated electric circuit as a processor of which a circuit configuration is designed exclusively for performing various types of processing.

One processing unit may be configured by one of these various processors, or may be configured by a combination of two or more same type or different type of processors (for example, a plurality of FPGAs, or a combination of a CPU and an FPGA). In addition, a plurality of the processing units may be configured by one processor. As an example in which the plurality of processing units are configured by one processor, first, there is a form in which one processor is configured by a combination of one or more CPUs and software, and this processor functions as the plurality of processing units, as represented by a computer, such as a client or a server. Second, there is a form in which a processor, which implements the functions of the entire system including the plurality of processing units with one integrated circuit (IC) chip, is used, as represented by a system on a chip (SoC) or the like.

As described above, various processing units are configured by one or more of the various processors described above, as the hardware structure. Further, the hardware structure of these various processors is, more specifically, an electric circuit (circuitry) having a form in which the circuit elements, such as semiconductor elements, are combined.

The storage memory stores the datasets for a learning model collected from a large number of providers. A built-in solid state drive (SSD) is preferably used for the storage. A recording medium, such as a universal serial bus (USB) memory or a hard disk drive (HDD), may be used instead of the SSD.

In addition, from the above description, it is possible to understand the learning model processing device described in the following supplementary notes 1 to 10.

### Supplementary Note 1

A learning model processing device comprising: a processor, in which the processor receives transmission of an encrypted learning model from a learning model generation device, acquires a dataset for a learning model, trains the learning model by using the dataset for a learning model through confidential computation, to derive an encrypted trained model, and transmits the trained model to the learning model generation device.

### Supplementary Note 2

The learning model processing device according to supplementary note 1, in which the processor divides the dataset for a learning model into a training dataset and an evaluation dataset, inputs the evaluation dataset to the trained model to acquire an evaluation result, and transmits quality data based on the evaluation result to the learning model generation device.

### Supplementary Note 3

The learning model processing device according to supplementary note 2, in which the processor performs anonymization processing on the evaluation result to generate the quality data.

### Supplementary Note 4

The learning model processing device according to supplementary note 2 or 3, in which the processor decides a price of the trained model to be paid by a user from the evaluation result, and transmits a billing amount based on the price to the learning model generation device.

### Supplementary Note 5

The learning model processing device according to supplementary note 4, in which the processor decides the price according to a type of data included in the dataset for a learning model.

### Supplementary Note 6

The learning model processing device according to supplementary note 4 or 5, in which the processor acquires a training-time evaluation result indicating accuracy during training, in the derivation of the trained model, calculates an overfitting degree from a deviation amount between the training-time evaluation result and the evaluation result, and reduces the billing amount according to the overfitting degree.

### Supplementary Note 7

The learning model processing device according to any one of supplementary notes 4 to 6, in which the processor stores a provider of data constituting the dataset for a learning model, receives response variable information for designating a condition of the data constituting the dataset for a learning model, together with the learning model, from the learning model generation device, and decides a reward amount to be paid, for each provider, based on the price, the response variable information, and a total number of records of the dataset for a learning model.

### Supplementary Note 8

The learning model processing device according to supplementary note 7, in which the processor groups the providers according to a type of data in the response variable information, and sets the reward amount to be paid to the provider of data that matches the type to be higher than the reward amount to be paid to the provider of data that does not match the type.

### Supplementary Note 9

The learning model processing device according to supplementary note 7 or 8, in which the processor presents the reward amount and the response variable information to the provider.

### Supplementary Note 10

The learning model processing device according to any one of supplementary notes 1 to 9, in which the dataset for a learning model is a health-related dataset, and the trained model is a trained model that has been trained by using health-related data.

### EXPLANATION OF REFERENCES

10: remote learning system
11: learning model generation device
12: learning model processing device
13: provider terminal
20: learning model generation unit
21: encryption processing unit
22: decryption key setting unit
23: response variable information decision unit
24: data transceiver unit
30: data-for-learning-model storage unit
31: confidential computation unit
32: evaluation data extraction unit
33: pre-processing unit
34: training processing unit
35: evaluation processing unit
40: price decision unit
41: overfitting determination unit
42: quality data creation unit
43: reward calculation unit
44: data transceiver unit
51: decryption key storage point
52: training dataset storage point
53: evaluation dataset storage point
54: pre-processed training dataset storage point
55: pre-processed evaluation dataset storage point
56: trained model storage point
57: evaluation result storage point
60: remote learning system
61: first learning model processing device
62: second learning model processing device
63: third learning model processing device
70: remote learning system
71: fourth learning model processing device
72: fifth learning model processing device
ST110 to ST210: step

What is claimed is:

1. A learning model processing device comprising:
a processor,
wherein the processor is configured to:
receive transmission of an encrypted learning model from a learning model generation device;
acquire a dataset for a learning model;
train the learning model by using the dataset for a learning model through confidential computation, to derive an encrypted trained model; and
transmit the trained model to the learning model generation device.

2. The learning model processing device according to claim 1,
wherein the processor is configured to:
divide the dataset for a learning model into a training dataset and an evaluation dataset;
input the evaluation dataset to the trained model to acquire an evaluation result; and
transmits quality data based on the evaluation result to the learning model generation device.

3. The learning model processing device according to claim 2,
wherein the processor is configured to perform anonymization processing on the evaluation result to generate the quality data.

4. The learning model processing device according to claim 2,
wherein the processor is configured to:
decide a price of the trained model to be paid by a user from the evaluation result; and
transmit a billing amount based on the price to the learning model generation device.

5. The learning model processing device according to claim 4,
wherein the processor is configured to decide the price according to a type of data included in the dataset for a learning model.

6. The learning model processing device according to claim 4,
wherein the processor is configured to:
acquire a training-time evaluation result indicating accuracy during training, in the derivation of the trained model;
calculate an overfitting degree from a deviation amount between the training-time evaluation result and the evaluation result; and
reduce the billing amount according to the overfitting degree.

7. The learning model processing device according to claim 4,
wherein the processor is configured to:
store a provider of data constituting the dataset for a learning model;
receive response variable information for designating a condition of the data constituting the dataset for a learning model, together with the learning model, from the learning model generation device; and
decide a reward amount to be paid, for each provider, based on the price, the response variable information, and a total number of records of the dataset for a learning model.

8. The learning model processing device according to claim 7,
wherein the processor is configured to:
group the providers according to a type of data in the response variable information; and
set the reward amount to be paid to the provider of data that matches the type to be higher than the reward amount to be paid to the provider of data that does not match the type.

9. The learning model processing device according to claim 7,
wherein the processor is configured to present the reward amount and the response variable information to the provider.

10. The learning model processing device according to claim 1,
wherein the dataset for a learning model is a health-related dataset, and
the trained model is a trained model that has been trained by using health-related data.

11. A remote learning system,
wherein datasets for a learning model used to train a learning model are distributed and held in a plurality of learning model processing devices as different datasets for a distributed learning model,
the learning model processing devices perform distributed learning using a confidential computation unit on the learning model, which is generated and encrypted by a learning model generation device, by using the datasets for a distributed learning model held in the respective learning model processing devices, and
the learning model generation device receives input of a trained model derived by the distributed learning.

12. The remote learning system according to claim 11,
wherein the remote learning system includes, as the plurality of learning model processing devices that perform the distributed learning, a first learning model processing device that holds a first dataset for a distributed learning model that is the dataset for a distributed learning model, and a second learning model processing device that holds a second dataset for a distributed learning model that is the dataset for a distributed learning model,
the first learning model processing device inputs the first dataset for a distributed learning model to the learning model transmitted from the learning model generation device and derives an in-middle-of-learning model that has stopped learning in a state in middle of learning, and
the second learning model processing device acquires the in-middle-of-learning model transmitted from the first learning model processing device, inputs the second dataset for a distributed learning model, and restarts the learning.

13. The remote learning system according to claim 11,
wherein the plurality of learning model processing devices that perform the distributed learning input the datasets for a distributed learning model into the learning model acquired from the learning model generation device and each derive a distributed-learning trained model, and
any one of the learning model processing devices integrates a plurality of the distributed-learning trained models to derive the trained model.

14. A non-transitory computer readable medium for storing a computer-executable program, the computer-executable program causing a computer to function:
a learning model transmission unit that receives transmission of an encrypted learning model from a learning model generation device and transmits a derived trained model to the learning model generation device;
a data acquisition unit that acquires a dataset for a learning model; and
a learning model training unit that trains the learning model by using the dataset for a learning model through confidential computation, to derive the trained model.
